(19) United States
(12) Patent Application Publication
(10) Pub. No.: US 2015/0154512 A1
(43) Pub. Date: Jun. 4, 2015

(54) METHOD FOR BOOKING TRAVEL ARRANGEMENTS

(71) Applicant: Wherefor, LLC, Dover, DE (US)

(72) Inventor: Ryan Wenger, Santa Monica, CA (US)

(73) Assignee: Wherefor, LLC, Dover, DE (US)

(21) Appl. No.: 14/095,141

(22) Filed: Dec. 3, 2013

(51) Int. Cl. G06Q 10/02; G06Q 50/14

(52) U.S. Cl. CPC G06Q 10/02; G06Q 50/14

(57) ABSTRACT

A method for identifying destinations within a user's travel budget, and booking airfare and accommodations for those destinations. The method may comprise: providing a server configured to host a website and databases for accessing the website; inputting a budget, point of origin, and travel dates; searching the airfare databases for flights based on the point of origin and travel dates; wherein the flights on those travel dates cost less than the budget; storing information of the cheapest flight in the server; searching the accommodations databases for accommodations in each of those destinations; storing matching accommodations in the server; displaying the list of all destinations where the price of airfare and the price of accommodations are within their budget; and allowing the user to book airfare and accommodations. These methods allow a user to search for and book the optimal combination of airfare and accommodations within their travel budget.

### FIELD OF INVENTION

This disclosure relates to methods that enable travelers to (1) identify destinations which are within their travel budget based upon real-time airfare and accommodation data, and that may match the travelers' geographic or lifestyle preferences, and; (2) book the optimal combination of airfare and accommodations for one or more selected destinations.

### BACKGROUND

When it comes to planning their vacations, most people start with two pieces of information: how much money they can spend, and what dates they want to travel. For most people, these two factors are a given. They have saved a certain amount of money for airfare plus accommodations, and they know which dates they will have off from work or school. What many people do not know is where they can afford to travel, given their budget and availability.

Currently, there is no method to enable travelers to identify all of the destinations to which they can afford to fly and lodge, based upon real-time information. Nor is there any method to enable travelers to identify all of the destinations where they might want to travel in the first place. Instead, the undecided traveler must use guess-work: he or she must select a handful of destinations that they are already familiar with, search for flights and accommodations for those locations, and then laboriously compare the results to determine the best travel destination. The limitation of this process is that it takes considerable time, and requires the traveler to know where they want to go in the first place. As a result, travelers never consider a multitude of relevant destinations that match their budget and personality. Consequentially, many travelers never take their perfect vacations, and instead opt to visit the same touristy places year after year.

To solve this problem what is needed is a method that determines where a traveler can afford to visit, based on their budget and dates of travel, which utilizes real-time flight and accommodation data. To make the results even more compatible for the traveler, the results may be filtered by various qualities that are important to that user, such as whether the destinations are warm, budget friendly, or offer a vibrant nightlife.

### SUMMARY OF THE INVENTION

To minimize the limitations in the prior art, and to minimize other limitations that will become apparent upon reading and understanding the present specification, the following discloses a method for users to input their dates of travel, budget, and various travel preferences, and the process finds the best places that fit all of those criteria. In essence, one embodiment process may be a multi-phase search that determines: (A) the price of cheapest flight, plus (B) the price of vacant accommodation; that (C) when combined is less than or equal to an entered budget. The resulting destinations may be ranked by the number of matching personality-criteria. The process may then enable the user to pick and book the optimal combination of accommodation and airfare to their chosen destination. By using this process, a person may save hours of search and planning time, and, visit places they may have never considered or thought they could afford.

One embodiment may be a method for booking travel arrangements, comprising: providing at least one server configured to host a website; providing one or more databases; wherein the website is configured to access the one or more databases; accessing the website on one or more computer systems by one or more users; prompting the one or more users to input a budget, one or more points of origin, and one or more travel dates by the website; inputting the budget, the one or more points of origin, and the one or more travel dates by the one or more users; searching the one or more databases by the website for a plurality of flights based on the one or more points of origin and the one or more travel dates; wherein the plurality of flights have an airfare cost that is less than the budget, such that a list of selected flights is generated; storing the list of selected flights in the at least one server; searching the one or more databases for a plurality of accommodations based on a plurality of destinations listed in the list of selected flights, the one or more travel dates, and an accommodations cost that is less than a remaining balance of the budget, such that a plurality of matching accommodations is created that matches up with the plurality of flights on the list of selected flights; wherein the remaining balance is an amount of the budget less the airfare cost; storing the one or more plurality of matching accommodations in the at least one server; and displaying to the one or more users the list of selected flights and the plurality of matching accommodations. The method may further comprise: selecting by the one or more users at least one of the plurality of flights listed on the list of selected flights and at least one of the plurality of matching accommodations, such that an itinerary is created. The website may not prompt the one or more users to enter one or more travel destinations when the one or more users input the budget. The displaying step of the plurality of matching accommodations may further comprise the step of: displaying the plurality of matching accommodations from most expensive to least expensive. The method for booking travel arrangements may further comprise: displaying a final balance of the budget to the one or more users; wherein the final balance may be an amount of the budget less the airfare cost and an accommodations cost. The at least one of the one or more databases may comprise a qualities database; wherein the qualities database may comprise a data of one or more qualities of one or more travel destinations. The method for booking hotel and travel may further comprise the step: prompting the one or more users to select a concierge service; wherein the concierge service may be configured to allow the one or more users to search one or more travel destinations based on the one or more qualities of the one or more travel destinations. The one or qualities may be selected from the group of qualities consisting of: a geographic region, a seasonal activity, and a language. The method for booking travel arrangements may further comprise the step of: displaying the one or more travel destinations based on the one or more qualities. The displaying step of the one or more travel destinations may be based on the one or more qualities, further comprises the step of: displaying a percentage; wherein the percentage may be a proportion of the one or more qualities in relation to the one or more travel destinations.

Another embodiment may be a method for booking travel arrangements, comprising: providing at least one server configured to host a website; providing one or more databases; wherein the website is configured to access the one or more databases; accessing the website on one or more computer systems by one or more users; prompting the one or more users to input a budget, one or more points of origin, and one or more travel dates by the website; inputting the budget, the one or more points of origin, and the one or more travel dates by the one or more users; searching the one or more databases by the website for a plurality of flights based on the one or more points of origin and the one or more travel dates; wherein the plurality of flights have an airfare cost that is less than the budget, such that a list of selected flights is generated; storing the list of selected flights in the at least one server; searching the one or more databases for a plurality of accommodations based on a plurality of destinations listed in the list of selected flights, the one or more travel dates, and an accommodations cost that is less than a remaining balance of the budget, such that a plurality of matching accommodations is created that matches up with the plurality of flights on the list of selected flights; wherein the remaining balance is an amount of the budget less the airfare cost; storing the one or more plurality of matching accommodations in the at least one server; displaying to the one or more users the list of selected flights and the plurality of matching accommodations; and selecting by the one or more users at least one of the plurality of flights listed on the list of selected flights and the plurality of matching accommodations, such that an itinerary is created. The website may not prompt the one or more users to enter one or more travel destinations when the one or more users input the budget. The displaying step of the plurality of matching accommodations may further comprise the step of: displaying the plurality of matching accommodations from most expensive to least expensive. The method for booking travel arrangements may further comprise: displaying a final balance of the budget to the one or more users; wherein the final balance may be an amount of the budget less the airfare cost and the accommodations cost. The at least one of the one or more databases may comprise a qualities database; wherein the qualities database may comprise a data of one or more qualities of the one or more travel destinations. The method for booking hotel and travel may further comprise the step: prompting the one or more users to select a concierge service; wherein the concierge service may be configured to allow the one or more users to search the one or more travel destinations based on the one or more qualities of the one or more travel destinations. The one or qualities may be selected from the group of qualities consisting of: a geographic region, a seasonal activity, and a language. The method for booking travel arrangements may further comprise the step of: displaying the one or more travel destinations based on the one or more qualities. The displaying step of the one or more travel destinations based on the one or more qualities may further comprise the step of: displaying a percentage; wherein the percentage may be a proportion of the one or more qualities in relation to the one or more travel destinations.

Another embodiment may be a method for booking travel arrangements, comprising: providing at least one server configured to host a website; providing one or more databases; wherein the website is configured to access the one or more databases; accessing the website on one or more computer systems by one or more users; prompting the one or more users to input a budget, one or more points of origin, and one or more travel dates by the website; inputting the budget, the one or more points of origin, and the one or more travel dates by the one or more users; wherein the website does not prompt the one or more users to enter one or more travel destinations when the one or more users input the budget; searching the one or more databases by the website for a plurality of flights based on the one or more points of origin and the one or more travel dates; wherein the plurality of flights have an airfare cost that is less than the budget, such that a list of selected flights is generated; storing the list of selected flights in the at least one server; searching the one or more databases for a plurality of accommodations based on a plurality of destinations listed in the list of selected flights, the one or more travel dates, and an accommodations cost that is less than a remaining balance of the budget, such that a plurality of matching accommodations is created that matches up with the plurality of flights on the list of selected flights; wherein the remaining balance is an amount of the budget less the airfare cost; storing the one or more plurality of matching accommodations in the at least one server; wherein at least one of the one or more databases comprise a qualities database; wherein the qualities database comprises a data of one or more qualities of the one or more travel destinations; prompting the one or more users to select a concierge service; wherein the concierge service is configured to allow the one or more users to search the one or more travel destinations based on the one or more qualities of the one or more travel destinations; receiving a selection of the concierge service from the one or more users; displaying to the one or more users the list of selected flights, the plurality of matching accommodations, a final balance of the budget, one or more travel destinations based on the one or more qualities, and a percentage; wherein the final balance is an amount of the budget less the airfare cost and the accommodations cost; wherein the percentage is a proportion of the one or more qualities in relation to the one or more travel destinations; and selecting by the one or more users at least one of the plurality of flights listed on the list of selected flights and at least one of the plurality of matching accommodations, such that an itinerary is created.

Another embodiment may be a method for booking travel arrangements, comprising: providing at least one server configured to host a website; accessing the website on one or more computer systems by one or more users; prompting the one or more users to input one or more search parameters by the website; receiving the one or more search parameters from the one or more users by the at least one server; storing the one or more search parameters in a memory of the at least one server; searching one or more databases to identify one or more travel options based on the one or more search parameters of the one or more users; displaying one or more identified travel options based on the one or more search parameters to the one or more users; wherein the one or more search parameters comprise a budget of the one or more users; and wherein the one or more identified travel options displayed to the one or more users have a total cost that is less than the budget of the one or more users. At least one of the one or more databases may comprise a qualities database; wherein the qualities database comprises a data of one or more qualities of the one or more travel destinations. The one or more search parameters may be selected from the group of search parameters consisting of: one or more travel dates; one or more travel destinations; one or more points of origin; and number of people traveling. The method for booking travel arrangements may further comprise the step of: providing an affiliate hotel network and an affiliate airfare network; wherein the affiliate hotel network and the affiliate airfare network comprise the one or more databases; and wherein the one or more databases comprise an information of the one or more travel options. The one or more search parameters may comprise a concierge service; wherein the concierge service may be configured to allow the one or more users to search one or more travel destinations based on the one or more qualities of the one or more travel destinations. The displaying step of the one or more travel options may further comprise the step of: displaying one or more travel destinations based on the one or more qualities. The displaying step of the one or more travel destinations based on the one or more qualities may further comprise the step of: displaying a percentage; wherein the percentage is a proportion of the one or more qualities in relation to the one or more travel destinations. The one or more displayed travel options may comprise: a price of the one or more airfares; a price of the one or more hotel accommodations; and a remaining balance of the budget of the one or more users. The displaying step of the one or more travel options may further comprise the step of: displaying the one or more hotel accommodations from most expensive to least expensive. The method for booking travel arrangements may further comprise: allowing the one or more users to select the one or more travel options to create an itinerary.

Another embodiment may be a method for booking travel arrangements, comprising: providing at least one server configured to host a website; accessing the website on one or more computer systems by one or more users; prompting the one or more users to input one or more search parameters by the website; receiving the one or more search parameters from the one or more users by the at least one server; storing the one or more search parameters in a memory of the at least one server; searching one or more databases to identify one or more travel options based on the one or more search parameters of the one or more users; displaying one or more identified travel options based on the one or more search parameters to the one or more users; and allowing the one or more users to select the one or more travel options to create an itinerary; wherein the one or more search parameters comprise a budget of the one or more users; and wherein the one or more identified travel options displayed to the one or more users have a total cost that is less than the budget of the one or more users. At least one of the one or more databases may comprise a qualities database; wherein the qualities database may comprise a data of one or more qualities of the one or more travel destinations. The one or more search parameters may be selected from the group of search parameters consisting of: one or more travel dates; one or more travel destinations; one or more points of origin; and number of people traveling. The method for booking travel arrangements may further comprise: providing an affiliate hotel network and an affiliate airfare network; wherein the affiliate hotel network and the affiliate airfare network may comprise the one or more databases; and wherein the one or more databases may comprise an information of the one or more travel options. The one or more search parameters may comprise a concierge service; wherein the concierge service may be configured to allow the one or more users to search one or more travel destinations based on the one or more qualities of the one or more travel destinations. The one or qualities may be selected from the group of qualities consisting of: a geographic region, a seasonal activity, and a language. The displaying step of the one or more travel options may further comprise the step of: displaying one or more travel destinations based on the one or more qualities. The displaying step of the one or more travel destinations based on the one or more qualities may further comprises the step of: displaying a percentage; wherein the percentage may be a proportion of the one or more qualities in relation to the one or more travel destinations. The one or more displayed travel options may comprise: a price of the one or more airfares; a price of the one or more hotel accommodations; and a remaining balance of the budget of the one or more users.

Another embodiment may be a method for booking travel arrangements, comprising: providing at least one server configured to host a website; providing an affiliate hotel network and an affiliate airfare network; wherein the affiliate hotel network and the affiliate airfare network comprise one or more databases; wherein the one or more databases comprise an information of the one or more travel options; wherein at least one of the one or more databases comprise a qualities database; wherein the qualities database comprises a data of one or more qualities of the one or more travel destinations; accessing the website on one or more computer systems by one or more users; prompting the one or more users to input one or more search parameters by the website; wherein the one or more search parameters comprise a budget of the one or more users; wherein the one or more identified travel options displayed to the one or more users have a total cost that is less than the budget of the one or more users; wherein the one or more search parameters comprise a concierge service; wherein the concierge service is configured to allow the one or more users to search one or more travel destinations based on the one or more qualities of the one or more travel destinations; wherein the one or qualities is selected from the group of qualities consisting of: a geographic region, a seasonal activity, and a language; receiving the one or more search parameters from the one or more users by the at least one server; storing the one or more search parameters in a memory of the at least one server; searching one or more databases to identify one or more travel options based on the one or more search parameters of the one or more users; wherein at least one of the one or more databases comprise a qualities database; wherein the qualities database comprises a data of one or more qualities of the one or more travel destinations; displaying one or more identified travel options based on the one or more search parameters to the one or more users; wherein the one or more displayed travel options comprise: a price of the one or more airfares; a price of the one or more hotel accommodations; and a remaining balance of the budget of the one or more users; displaying one or more travel destinations based on the one or more qualities; displaying a percentage; wherein the percentage is a proportion of the one or more qualities in relation to the one or more travel destinations; and allowing the one or more users to select the one or more travel options to create an itinerary.

It is an object to overcome the limitations of the prior art.

Additional embodiments will be understood from the following detailed description of the invention.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a flow chart of one embodiment of the method for booking travel arrangements.

FIG. 2 is a block diagram of one embodiment of a computer system.

FIG. 3 is a flow diagram of one embodiment of a system for booking travel arrangements.

FIG. 4 is a screenshot of one embodiment of the website for booking travel arrangements and shows one embodiment of the introduction webpage.

FIG. 5 is a screenshot of another embodiment of the website for booking travel arrangements and shows one embodiment of the basic search webpage.

FIG. 6 is a screenshot of another embodiment of the website for booking travel arrangements and shows one embodiment of the search results webpage if concierge service is not selected.

FIG. 7 is a screenshot of another embodiment of the website for booking travel arrangements and shows one embodiment of the concierge service screen.

FIG. 8 is a screenshot of another embodiment of the website for booking travel arrangements and shows one embodiment of the search results webpage if concierge service is selected.

FIG. 9 is a screenshot of one embodiment of a confirmation email sent by the server after the travel options have been selected.

FIGS. 10A and 10B are flow charts of a preferred embodiment of the method for booking travel arrangements.

### DETAILED DESCRIPTION OF THE INVENTION

In the following detailed description of various embodiments of the method for booking travel arrangements, numerous specific details are set forth in order to provide a thorough understanding of various aspects of one or more embodiments. However, the one or more embodiments may be practiced without some or all of these specific details. In other instances, well-known methods, procedures, and/or components have not been described in detail so as not to unnecessarily obscure aspects of embodiments.

While multiple embodiments are disclosed, still other embodiments of the method for booking travel arrangements will become apparent to those skilled in the art from the following detailed description, which shows and describes illustrative embodiments of the method. As will be realized, the following disclosure is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, the terms “computer”, “computer system”, “server”, and “electronic data processing unit” may refer to any device that processes information with an integrated circuit chip, including without limitation, mainframe computers, work stations, servers, desktop computers, portable computers, laptop computers, embedded computers, wireless devices including cellular phones, tablet computers, personal digital assistants, digital media players, portable game players, and hand-held computers.

As used herein, the term “Internet” may refer to any collection of networks that utilizes standard protocols, whether Ethernet, Token ring, Wi-Fi, asynchronous transfer mode (ATM), Fiber Distributed Data Interface (FDDI), code division multiple access (CDMA), global systems for mobile communications (GSM), long term evolution (LTE), or any combination thereof.

As used herein, the terms “application”, “software”, and “software application” generally refer to any set of machine-readable instructions on a client machine, web interface, and/or computer system, that directs a computer's processor to perform specific steps, processes, or operations disclosed herein.

As used herein, the terms “webpage”, “page”, “website”, or “site” generally refers to any of the various documents and resources on the World Wide Web, in HTML/XHTML format with hypertext links to enable navigation from one page or section to another, or similar such resources used on the Internet. The webpage, page, website, or site may utilize a separate search engine and may engage in performing searches on various databases.

The terms “qualities”, “travel qualities”, and “qualities of one or more travel destinations” may refer to any characteristic, feature, or distinctive attribute possessed by an area location belonging to or distinguishing one travel destination from another. Such qualities may include, without limitation, locations based on: climate (e.g., summer, winter, spring, and fall), geographic features (e.g., beaches, mountain summits), seasonal activities (e.g., snowboarding, surfing, horseback riding, camping), nightlife, historical sites (e.g., buildings, landscapes, sites or structures that are of local, regional, or national significance), food popularity, marital status (e.g., single men or single women), sexual orientation friendly (e.g., heterosexual, gay, bisexual), budget (e.g., cheaper lodging and entertainment), expensive, artistic (e.g., museums and galleries), gambling (e.g., casinos), hipster locations (e.g., artsy, budget friendly, foodie locations, etc. . . . ), family friendly locations, romance (e.g., honeymoon locations), fashion (i.e., locations known for fashion or shopping). Such qualities may also include locations based on a particular language (e.g., English, French, German, Japanese, Mandarin, Spanish, etc. . . . ), and/or particular continent (e.g., Asia, Europe, North America, South and Central America, Africa, Middle East, and India).

The terms “travel option” and “identified travel option” may refer to any airfare or hotel accommodations that are searched, selected, and presented to the user for creating an itinerary for the user.

The term “travel destination” generally refers to any geographical location, city, or place to which a person intends to travel or is sent to on business.

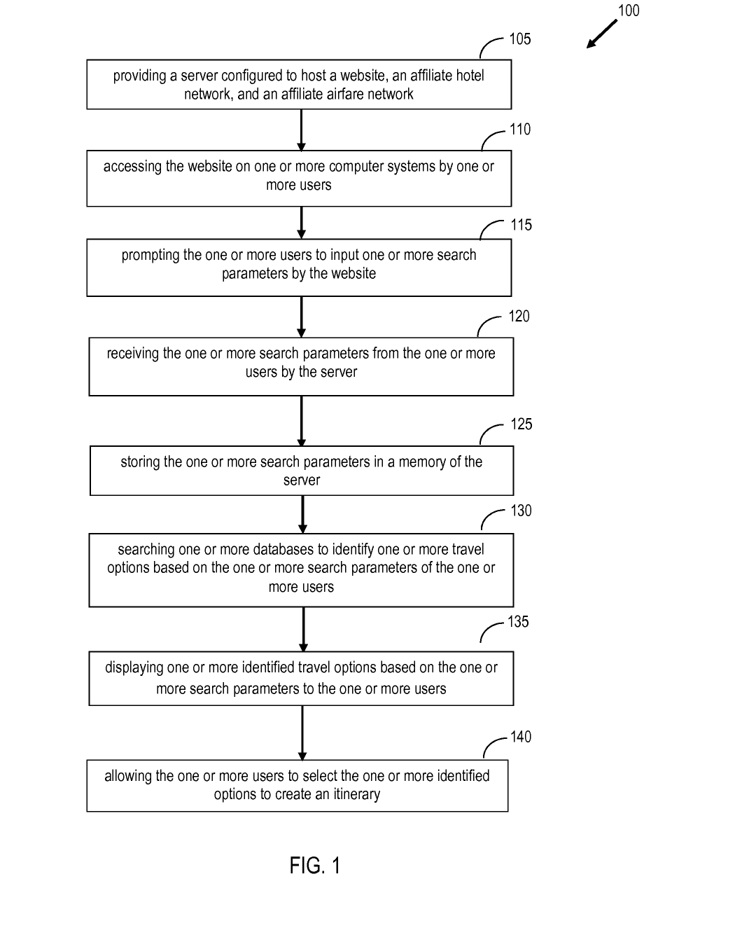

FIG. 1 is a flow chart of one embodiment of the method for booking travel arrangements. As shown in FIG. 1, one embodiment of the method 100 may comprise: providing at least one server configured to host a website, an affiliate hotel network, and an affiliate airfare network 105; accessing the website on one or more computer systems by one or more users 110; prompting the one or more users to input one or more search parameters by the website 115; receiving the one or more search parameters from the one or more users by the server 120; storing the one or more search parameters in a memory of the server 125; searching one or more databases to identify one or more travel options based on the one or more search parameters of the one or more users 130; displaying one or more identified travel options based on the one or more search parameters to the one or more users 135; and allowing the one or more users to select the one or more identified travel options to create an itinerary 140.

FIG. 1 shows the first step of the method 100, which may be providing at least one server configured to provide a website, an affiliate network, and an affiliate airfare network 105. The website may be any set of interconnected webpages (usually including a homepage and generally located on the server) and may be prepared and maintained as a collection of information by a person, group, or organization. The website may be configured to prompt a user to enter his or her username and password information and may be capable of receiving and sending hypertext transfer protocol (HTTP) requests or a web container that generally provides an environment for servlets and Java Server Pages (JSP) to run. Additionally, the website may gather browser history, internet protocol (IP) location, and other information from the user, and may provide additional webpages such as travel blogs to encourage users to revisit the website and to keep the website relevant in searches by search engines.

The at least one server may be a system (i.e., software and suitable computer hardware) that responds to requests across a computer network to provide, or help to provide, airfare, hotel, and travel accommodations for that website. In a preferred embodiment, the server may host the website in the Internet.

The affiliate hotel network and an affiliate airfare network may be any collection of networks that utilize multiple databases for searching flights. The affiliate hotel network may be used for searching affordable hotel accommodations on the selected travel dates, whereas the affiliate airfare network may be used for searching the most affordable airfare on the those travel dates. Generally, the number of destinations and number of hotel accommodations that are available may depend on the technical capacity of the chosen affiliate network.

The databases may comprise a “qualities” database, which may be any structured set of data used to characterize certain qualities of a particular destination. The data and information contained in a qualities database may be compiled by a team of well-traveled researchers who analyze each particular travel destination and may also be compiled based on reviews of each travel destination, promotional literature for that travel destination, and the like. In a preferred embodiment, the data and information in the qualities database may be used for searching travel arrangements via the concierge service.

FIG. 1 also shows the second step of the method 100, which may be accessing the website on one or more computer systems by one or more users 110. A user of a computer system may access the webpages of the website by utilizing a computer system. The computer system may be any device with an electronic data processor such as a personal computer, tablet, or smartphone, but may also be any device that is capable of accessing the website, such as a smart television set. In a preferred embodiment, the computer system comprises a web browser that may be configured for a user to visit or access the website to perform the method 100.

The method 100 may also comprise the third and fourth steps, which may be prompting the one or more users to input one or more search parameters by the website 115 and receiving the one or more search parameters from the one or more users by the server 120. After the user accesses the website on the computer system, the website may prompt the user to input search parameters into the website to search hotel and flight information and book certain hotels and airfare. Such search parameters may comprise personal user information, including but not limited to: budget, number of travelers, dates of travel, locations for traveling (destinations and starting locations), and concierge service. The concierge service may be one or more search parameters that allow the user to select certain travel destinations based on the dynamic preferences of the user or the desired qualities of the travel destinations. For example, such qualities may be based on, but are not limited to, climate, geographic features, seasonal activities, nightlife, historical sites, food popularity, marital status, sexual orientation, budget/expense of living in the destination, luxury, art scene, wine culture, foodie scene, outdoor recreation, gambling, continent, hipster locations, romance, fashion, dog or pet friendly, and languages spoken. Such qualities may be created and corresponded with a particular travel destination by researching the most popular cities/destinations in the world for traveling. For example, in one embodiment, the researching experts may find and correspond the city of Rio de Janeiro with the qualities of: nightlife; beaches; budget friendly; summertime (if the travel dates are between November 1 to April 15), single men; and South America. Also, when selecting the concierge service, the user may be asked to login to the website via a username and password. After being prompted by the website, the user may input such search parameters in order for the server to receive the one or more search parameters.

The method 100 may also comprise the fifth and sixth steps—i.e., storing the one or more search parameters in a memory of the server 125 and searching one or more databases to identify one or more travel options based on the one or more search parameters of the one or more users 130. After the user has inputted his or her search parameters into the website of the server, the search parameters may be stored in the memory of the server. Once the search parameters are stored in the memory or cache of the server, the server may perform a search on one or more databases, for example, the databases might databases of an affiliated airfare networks (e.g., ITA software, Priceline®, Expedia®, Airline Tariff Publishing Company (APTCO)) and hotel networks, in response to the user's needs. This may involve comparing the search parameter information of the user with other information located in other databases. For example, if the search parameter of the user includes a certain budget, the budget data may be stored in the server and may be used to compare with other airfare and hotel prices that the user can afford. Specifically, the server may run a search in an affiliate network for travel destinations where the total airfare ticket prices is below the total budget of the user on the selected travel dates. Information for travel destinations where the total airfare ticket price for all travelers is below the user's budget may be temporarily stored in a certain memory location or cache in the server (e.g., “flagged destination” cache), and the cheapest flight information(s) may be stored in the temporary cache (e.g., cache labeled “airfare”). The amount remaining in the total budget, after the airfare is deducted, may be stored in the accommodations budget.

Similarly, the server or website may run another search in the one or more affiliate hotel networks to determine those hotel and lodging accommodations that are affordable for each flagged destination on the selected travel dates. For each flagged destination, the website may search for hotels, hostels, or rental homes which may be: (1) available during the selected travel dates, and (2) less than or equal to the budget of the user. Any destination without accommodations matching both criteria may be eliminated and the most expensive/highest quality hotel(s) within the budget may be selected and stored in the temporary cache (e.g., “Accommodation” cache). This generally allows the method 100 to select the most expensive/highest quality hotel available after the costs of the cheapest airfare is deducted. A user may thus visualize and compare what quality of hotel he or she can afford to stay if the user visits different destinations with the same budget.

Finally, FIG. 1 also shows the seventh and eight steps—i.e., displaying one or more identified travel options based on the one or more search parameters to the one or more users 135 and allowing the one or more users to select the one or more identified travel options to create an itinerary 140. After the server has performed a search on other databases based on the search parameters, the website may display one or more identified travel options for booking travel. Specifically, the identified travel options that are displayed to the user may have a total cost that is less than the budget indicated by the user. The travel options may be airfare accommodations and hotel accommodations and may be displayed in a certain order. For instance, the travel options may be displayed alphabetically or based upon the user's budget (e.g., airfare that is least expensive to most expensive, or hotel accommodations from most expensive to least expensive). The website may also display other travel option information such as the price of the airfares, price of the hotel accommodations, and remaining balance of the user's budget. In an alternative embodiment, the website may display one or more travel destinations based on the desired qualities of the travel destinations. The website may also display a percentage, which may indicate the proportion of the qualities in relation to a particular travel destination. After the travel options are displayed to the user, the user may select those travel options that he or she desires, thereby creating an itinerary for his or her travel. Alternatively, the user may modify components of the travel options to further customize his or her itinerary. For example, if the user decides to change hotel accommodations, the user may be able to see what hotels in that city are vacant and the difference in budget during the selected travel dates. The user may also increase the accommodations budget, modify the room type, and/or modify the airfare component. For example, if the user decides to modify the airfare component, the user may be able to see what air carriers and flight times are available within the airfare budget during the days of travel. The user may also increase their airfare budget or modify the airfare by class, dates, and layovers.

Although FIG. 1 shows only eight steps, it should be understood that any number of steps may be used, and that some steps may be performed at the same time or out of order. For example, after the user selects his or her desired travel options, the user may be directed to a payment screen and/or confirmation screen. In the payment screen, the user may login with a username and password, unless the website has already logged the user previously (e.g., via the concierge service). The user may also provide payment for the desired travel option using his or her credit card information, and various combinations of travel options may be completed in a single transaction.

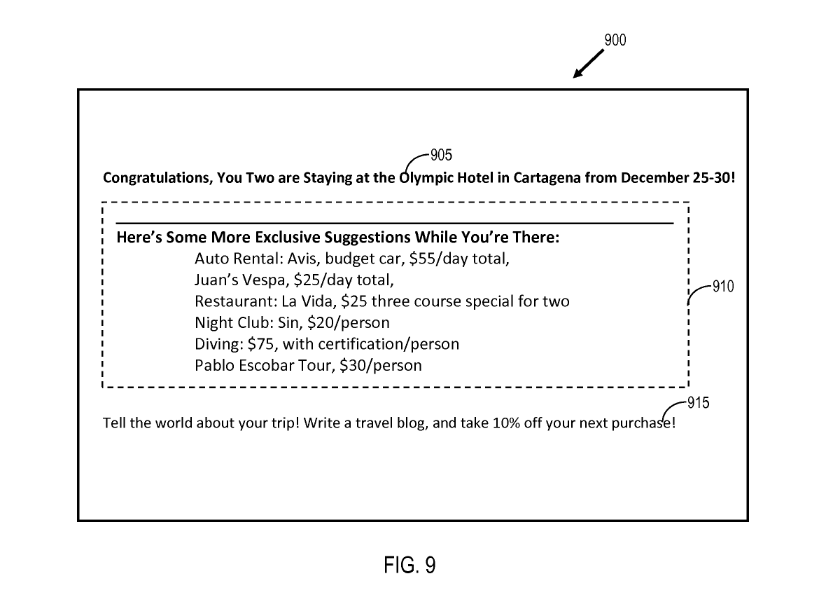

Regarding the confirmation screen, the user may be presented with three confirmation numbers: (1) the confirmation number created by the company or website; (2) the air carrier's confirmation number; and (3) the hotel or hostel's confirmation number. In the confirmation screen, the user may also be asked to explain the details about his or her trip via a travel blog and that a confirmation email (shown in FIG. 9) may be sent to the user. The confirmation email may identify all the information above, but may also include additional information such as travel discounts based on a certain destination and personality profile.

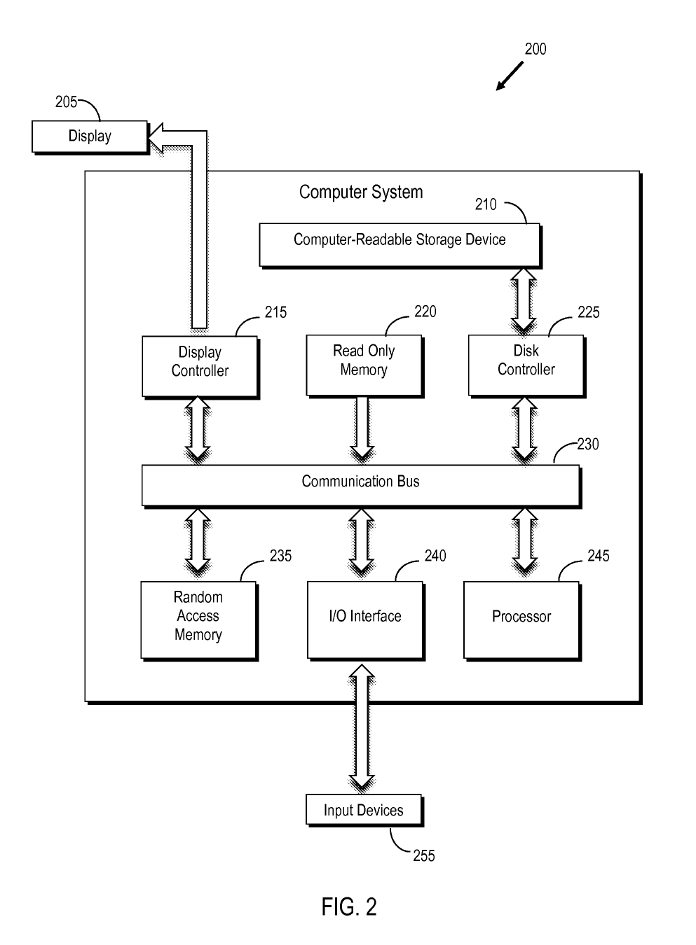

FIG. 2 is a block diagram of one embodiment of a computer system. As shown in FIG. 2, one embodiment of a computer system 200 may comprise: a display 205; computer-readable storage device 210; display controller 215; read only memory (ROM) 220; disk controller 225; communication bus 230; random access memory (RAM) 235; input/output interface (I/O interface) 240; processor 245; and one or more input devices 255. In various embodiments, the computer system 200 may be a personal computer or mobile computing device that comprises a processor 245 connected through a communication bus 230, which may connect to other various electronic hardware, including without limitation, a display controller 215, RAM 235; ROM 220; disk controller 225; and I/O interface 240. The disk controller 225 may be configured to control the computer-readable storage device 210, which may be a hard drive, optical disk drive, or another form of computer memory. The display controller 215 is generally connected to the display 205 such as a liquid crystal display (LCD), projection system, or touchscreen. The computer system 200 may also have at least one display screen to display the search results to a user and may include, without limitation, an liquid crystal display (LCD), cathode ray tube (CRT), light emitting diode (LED), and the like. The I/O interface 240 may be connected to one or more input devices such as a keyboard and/or mouse.

The processor 245 may be configured to execute a set of computer readable instructions and further to execute one or more applications or computer program such as the web browser. In other various embodiments, the computer readable instructions or application may be tangibly embodied in the memory of the computer system such as the RAM 235 or ROM 220, or on a computer-readable storage medium, such as a magnetic, optical or solid-state digital storage medium. The computer system 200 may also include other components without deviating from the scope of the invention.

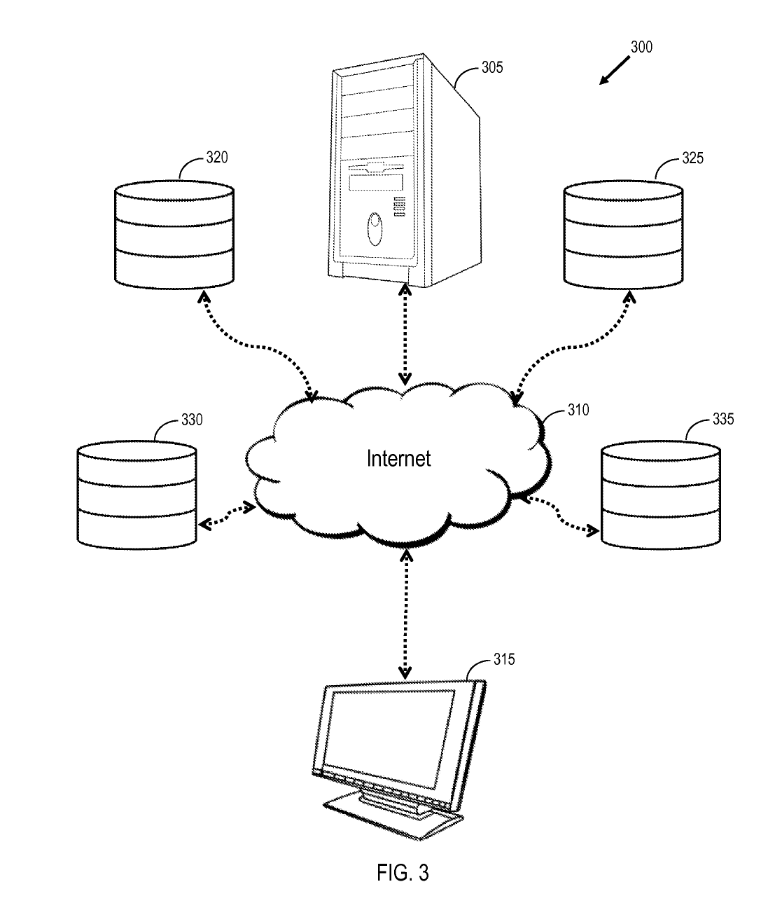

FIG. 3 is a flow diagram of one embodiment of a system for booking travel arrangements. As shown in FIG. 3, an embodiment of the system 300 for booking travel arrangements may comprise: one or more servers 305, Internet 310, computer system 315, and one or more databases 320, 325, 330, 335. The server 305 may be another computer system or computer program that manages access to a centralized resource or service in a network and may host a website for online travel booking. The Internet 310 may be a computer network comprising a worldwide network of computer networks that use the TCP/IP network protocols to facilitate data transmission and exchange. The computer system 315 may be any computing device designed for individual use such as browsing the Internet 310 or World Wide Web, and may be used for booking hotel and travel through the present method 100. The databases 320, 325, 330, 335 may be any hardware configuration with a central processing unit used to store data for the databases of various travel booking sites.

FIG. 3 also shows how the method 100 may be performed. Specifically, a user may access a website of the server 305 via the Internet 310 through the computer system 315. In response, the website may prompt the user to input one or more search parameters. After inputting search parameters into the website, the server 305 may receive the search parameters from the user and store those search parameters into the server's memory or cache. The server 305 then may search one or more databases to identify travel options based on the search parameters of the user. This may involve reviewing data stored in databases 320, 325, 330, 335. After reviewing the deals, the computer system 315 may display one or more travel options to the user, and the user may then select certain travel options to create an itinerary. Although FIG. 41 shows the system 300 with four different databases 320, 325, 330, 335, the system 300 may function with any number of databases.

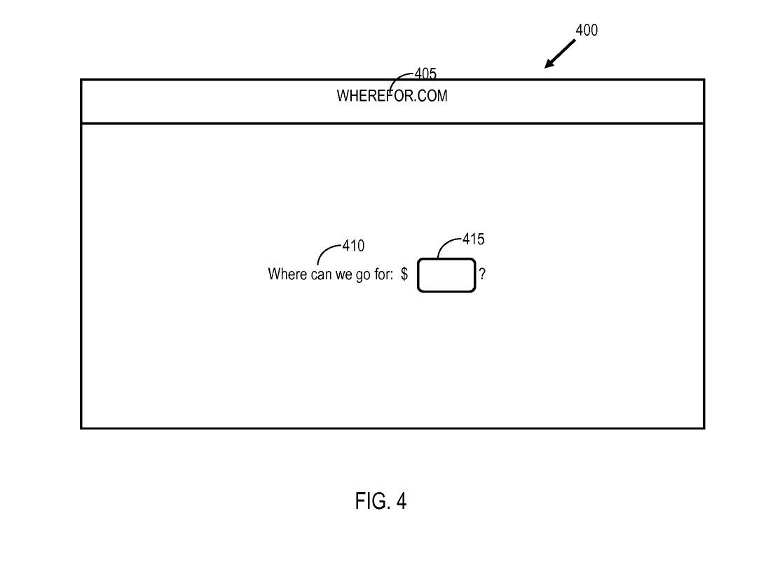

FIG. 4 is a screenshot of one embodiment of the website for booking travel arrangements and shows one embodiment of the introduction webpage. As shown in FIG. 4, one embodiment of introduction webpage 400 of the website may comprise: a title 405, a prompt 410; and an input field 415. The title 405 may be the title of the website hosted on the server 305 or the name of the company. A prompt 410 may be any instruction, question, tutorial, or message by the website used to alert the user to enter a search parameter into an input field 415. For example, as shown in FIG. 4, the website may prompt the user to input a budget by stating “Where can we go for?”. The user may then enter his or her budget amount into the input field 415.

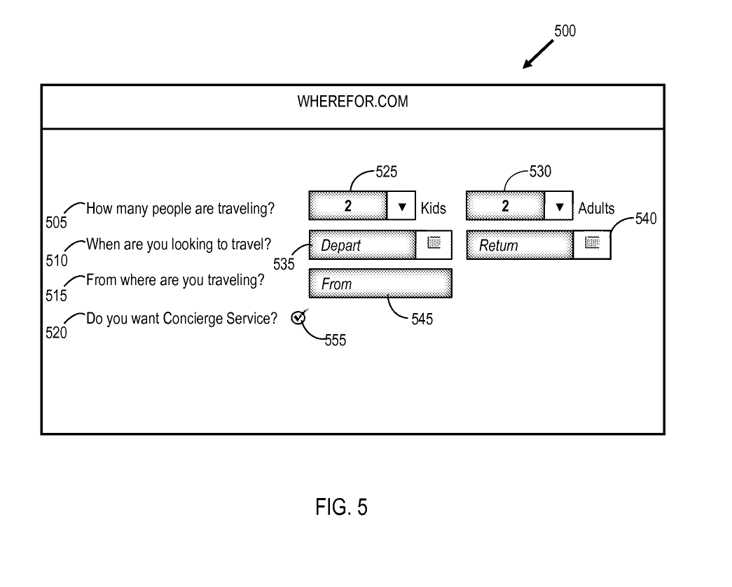

FIG. 5 is a screenshot of another embodiment of the website for booking travel arrangements and shows one embodiment of the basic search webpage. As shown in FIG. 5, one embodiment of the basic search webpage 500 of the website may comprise: prompts 505, 510, 515, 520; input fields 525, 530, 535, 540, 545, 550; and a checkbox 555. The prompts 505, 510, 515 may ask the user to input additional search parameters into the input fields 525, 530, 535, 540, 545, 550, and the input fields 525, 530, 535, 540, 545, 550 may be used to enter those search parameters in response to the prompts 505, 510, 515. For instance, prompt 505 may ask the user to input the number of travelers while input field 525 and input field 530 may be used to enter the number of kids and adults traveling. Similarly, prompt 510 may ask the user to input the dates for traveling, while input field 535 and input field 540 may be entered to input the departing date and the return date. Additionally, prompt 515 may ask the user to input the travel locations, while input field 545 and field 550 may be used to enter the departing location and desired travel destination. In an embodiment, the name of the departing location and travel destination may be auto-populated. Although FIG. 5 shows that a destination may be inserted, in a preferred embodiment, the destination field is not completed. Finally, prompt 520 may ask the user if he or she would like concierge service. In response, the user may select the checkbox 555 to include concierge service for his or her itinerary and may be led to a concierge service screen for selecting one or more qualities that would be desired in the user's selection for a travel destination. Although FIG. 5 shows four prompts, any number prompts may be shown in the website without deviating from the scope of the invention. Additionally, although FIG. 5 shows that the number of travelers may be divided into kids and adults, the method 100 may include a search parameter of the total number of travelers without the distinguishing adults and kids.

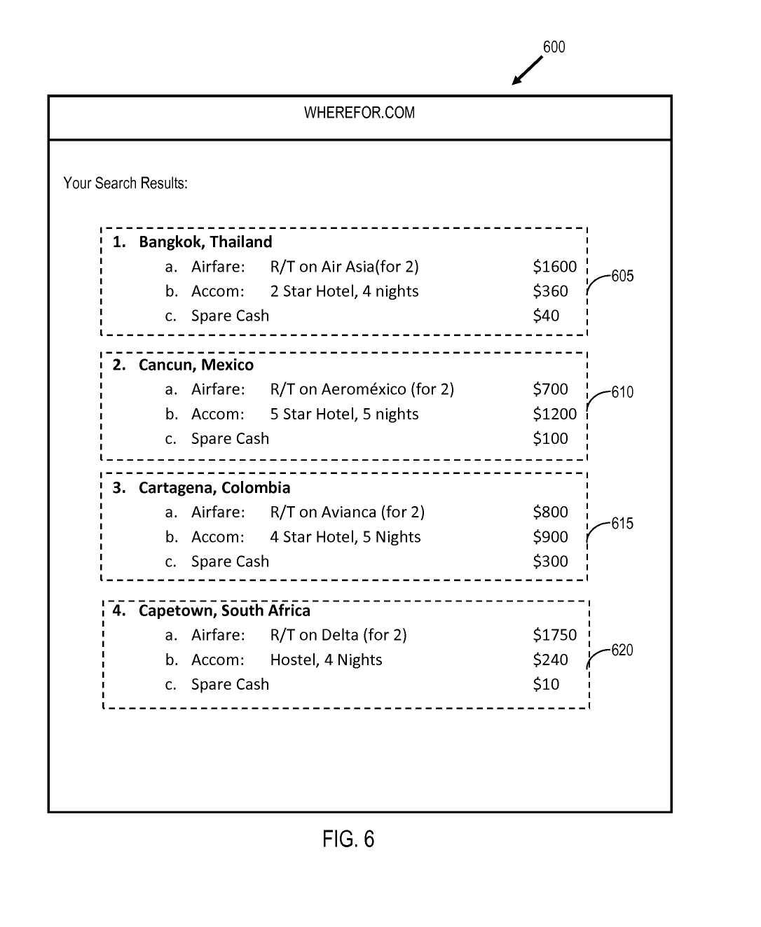

FIG. 6 is a screenshot of another embodiment of the website for booking travel arrangements and shows one embodiment of the search results webpage if concierge service is not selected. As shown in FIG. 6, one embodiment of the search results webpage 600 of the website may comprise travel options 605, 610, 615, 620. Each travel option may be a potential travel destination in which the user may select for traveling and may comprise the price for the airfare, price for hotel accommodations, and remaining spare cash for the user. For example, based on a user's budget of $2,000, travel option 605 shows that a trip to Bangkok, Thailand may result with an airfare expense of $1,600, hotel expense of $360, and remaining spare cash of $40. Similarly, a trip to Cancun, Mexico may result with an airfare expense of $700, hotel expense of $1,200, and remaining spare cash of $100.

The travel options 605, 610, 615, 620 may be arranged in alphabetical order or based on budget (e.g., from least expensive to most expensive airfare, from most expensive hotel to least expensive hotel). For example, the website may list the travel options from the cheapest airfare and most expensive hotel available to the most expensive airfare and least expensive hotel available. The user may also edit the information in the identified travel options by selecting and changing various airfare and hotel lodging accommodations. Although FIG. 6 shows four travel options, it should be understood that any number of travel options may be displayed by the website. Additionally, although FIG. 6 shows the travel options displayed in alphabetical order, the travel options may be displayed in any order.

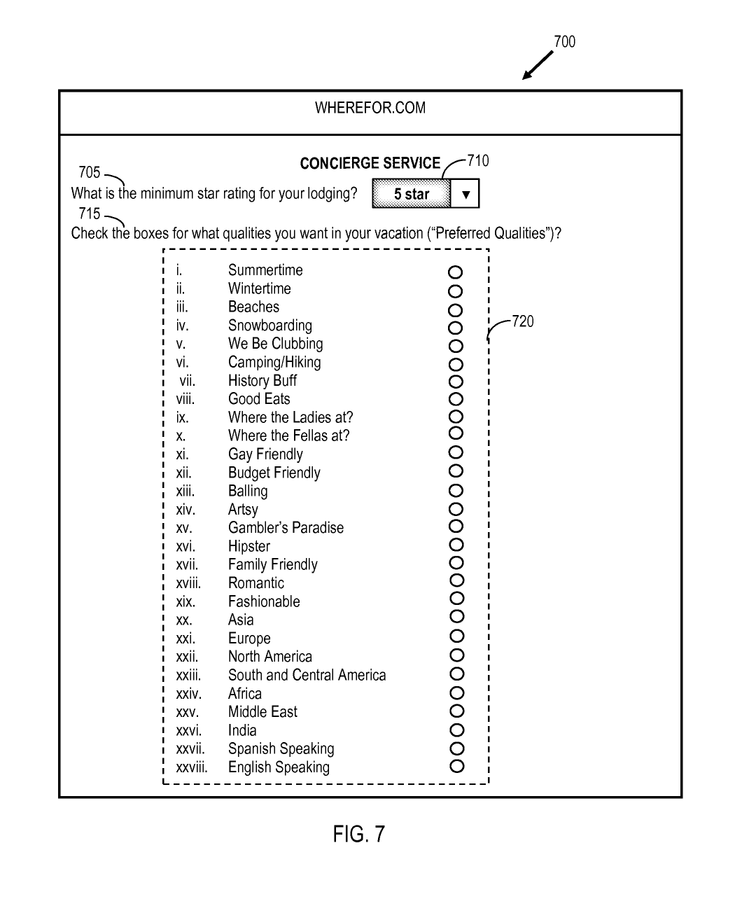

FIG. 7 is a screenshot of another embodiment of the website for booking travel arrangements and shows one embodiment of the concierge service screen. As shown in FIG. 7, another embodiment of the concierge service screen 700 may comprise: prompts 705, 715; input field 710; and qualities 720. Prompt 705 may ask the user to input an additional search parameter of a minimum star rating for hotel lodging accommodations, and the user may enter the desired minimum star rating for a particular accommodation in input field 710. Additionally, prompt 715 may also ask the user to input additional search parameters of “preferred qualities” or qualities 720 of certain travel destination locations. As discussed above, qualities 720 may refer to any characteristic, feature, or distinctive attribute possessed by a specific area location belonging to or distinguishing one travel destination from another. When reviewing the qualities 720, additional information may be presented to the user about each quality. For example, when moving the cursor over the Summertime Quality, additional information such as “Limits search based on geography and season” may appear to the user. Similarly, when moving the cursor over the quality “Snowboarding”, additional information “geographic feature and season” may appear. The user may then, in response to prompt 715, select certain qualities 720 that he or she desires in a travel destination. Based on the user's selection for those qualities 720 that he or she selects, the website may then display search results of travel destinations with respect to those qualities 720 or attributes that the user desires. The qualities 720 may not be required for each search result but may be required in alternative embodiments. Thus, if a travel destination does not include a particular quality, certain travel options may or may not be listed as a travel option. It should be understood that any number of qualities can be displayed. It should also be understood that the destination qualities can include any quality or feature of a destination, including, but not limited to geographic, climatic, population, demographic, location, urban scene, crime, events, seasonal events, natural recreational opportunities, man-made recreational opportunities, reputation, types of visitors, reviews, and other broad qualities and features.

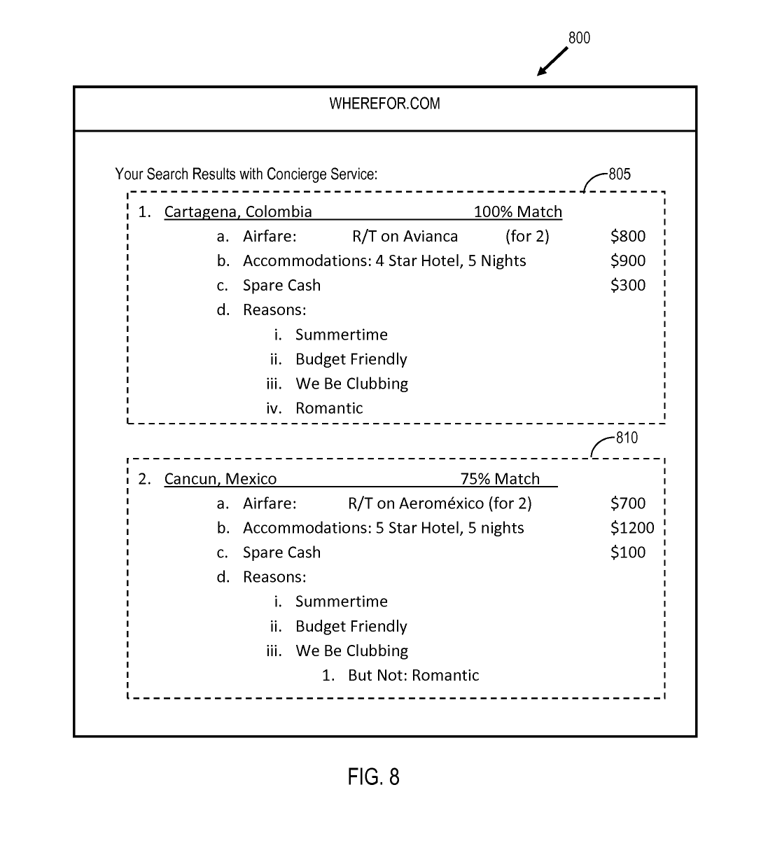

FIG. 8 is a screenshot of another embodiment of the website for booking travel arrangements and shows one embodiment of the search results webpage if concierge service is selected. As shown in FIG. 8, another embodiment of the search results webpage 800 of the website may comprise travel options 805, 810. Each travel option may be a potential travel destination in which the user may select for traveling based on the user's budget and qualities 720 of the destination selected by the user. Each travel option 805, 810 may comprise: the price for the airfare, price for hotel accommodations, remaining spare cash for the user, and qualities 720 of that travel destination selected by the user. Each travel option 805, 810 may also comprise a percentage that may indicate the proportion of the qualities 720 present in relation to the travel destination. For example, based on a user's budget of $2,000, travel option 805 shows that a trip to Cartagena, Colombia may result with an airfare expense of $800, hotel expense of $900, and remaining spare cash of $300. That travel option 805 may also show a percentage of 100% with qualities 720 of Summertime, Budget Friendly, We Be Clubbing, and Romantic. Similarly, travel option 810 shows that a trip to Cancun, Mexico may result with an airfare expense of $700, hotel expense of $1,200, and remaining spare cash of $100 with a percentage of 75% with qualities 720 of Summertime, Budget Friendly, and We Be Clubbing, but not Romantic. The travel options 805, 810 may be arranged in alphabetical order, based on budget (e.g., from least expensive to most expensive airfare, from most expensive hotel to least expensive hotel) or based on percentages (e.g., from highest percentage to lowest percentage). Although FIG. 8 shows two travel options, it should be understood that any number of travel options may be displayed by the website. Additionally, although FIG. 8 shows the travel options displayed in order of highest percentage, the travel options may be displayed in any order.

FIG. 9 is a screenshot of one embodiment of a confirmation email sent by the server after the travel options have been selected. As shown in FIG. 9, one embodiment of a confirmation email 900 may comprise: confirmation message 905 and travel discounts/opportunities 910, 915. The confirmation message 905 may confirm that the user has selected a particular travel option and may comprise of the travel destination and travel dates. The confirmation message 905 may also comprise of other information such as airfare information. The travel discount 910 may be one or more travel options suggested by the website or method 100 and may comprise of various airfares and travel destinations (e.g., lodging and hotel accommodations, restaurants, entertainment). Travel discount 915 may also be suggested to the user to rate or explain his or her travel experience in order to get an additional discount for the user's next purchase.

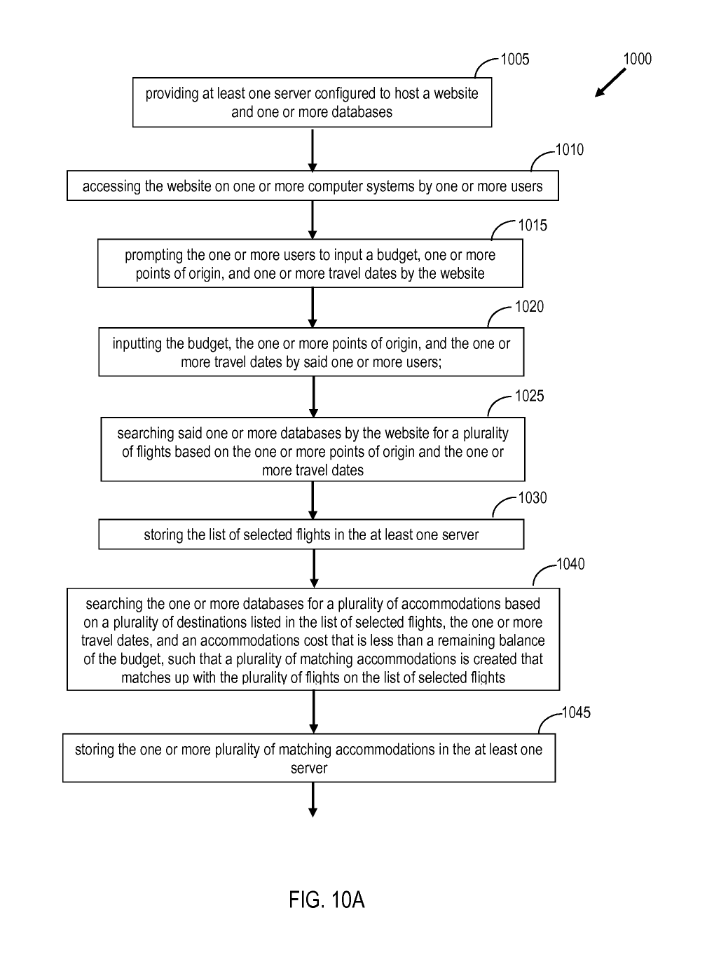

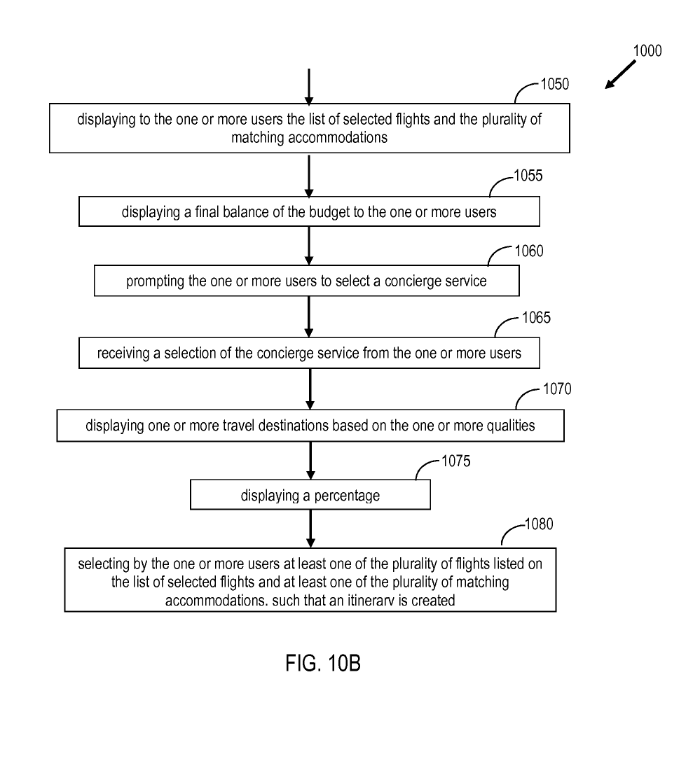

FIGS. 10A and 10B are flow charts of a preferred embodiment of the method for booking travel arrangements. Although the steps shown in FIGS. 10A and 10B are shown as contiguous or in order, the steps do not need to be practiced in the order shown and some steps need not be included at all. As shown in FIGS. 10A and 10B, a preferred embodiment of the method 1000 may comprise: providing at least one server configured to host a website and providing one or more databases 1005; accessing the website on one or more computer systems by one or more users 1010; prompting the one or more users to input a budget, one or more points of origin, and one or more travel dates by the website 1015; inputting the budget, the one or more points of origin, and the one or more travel dates by the one or more users 1020; searching the one or more databases by the website for a plurality of flights based on the one or more points of origin and the one or more travel dates 1025; storing the list of selected flights in the at least one server 1030; searching the one or more databases for a plurality of accommodations based on a plurality of destinations listed in the list of selected flights, the one or more travel dates, and an accommodations cost that is less than a remaining balance of the budget, such that a plurality of matching accommodations is created that matches up with the plurality of flights on the list of selected flights 1040; storing the one or more plurality of matching accommodations in the at least one server 1045; displaying to the one or more users the list of selected flights and the plurality of matching accommodations 1050; displaying a final balance of the budget to the one or more users 1055; prompting the one or more users to select a concierge service 1060; receiving a selection of the concierge service from the one or more users 1065; displaying one or more travel destinations based on the one or more qualities 1070; displaying a percentage 1075; and selecting by the one or more users at least one of the plurality of flights listed on the list of selected flights and at least one of the plurality of matching accommodations, such that an itinerary is created 1080.

FIGS. 10A and 10B show the first step of the method 1000, which may be providing at least one server configured to host a website and providing one or more databases 1005. As discussed above, the website may be any set of interconnected webpages that may be prepared and maintained as a collection of information by a person, group, or organization. The website may be configured to prompt a user to enter his or her username and password information and may be capable of receiving and sending hypertext transfer protocol (HTTP) requests or a web container that generally provides an environment for servlets and Java Server Pages (JSP) to run. Additionally, the website may gather browser history, internet protocol (IP) location, and other information from the user, and may provide additional webpages such as travel blogs to encourage users to revisit the website and to keep the website relevant in searches by search engines.

The server may be a system (i.e., software and/or suitable computer hardware) that responds to requests across a computer network to provide, or help to provide, airfare, hotel, and travel accommodations for that website. In a preferred embodiment, the server may host the website in the Internet.

The databases are generally one or more collections of pieces of information that are organized and used on a computer or server such as flight information such as flights, airfare, accommodations (e.g., hotel and lodging accommodations). The databases may comprise a “qualities” database, which may be any structured set of data used to characterize certain qualities of a particular destination. The data and information contained in a qualities database may be compiled by a team of well-traveled researchers who analyze each particular travel destination and may also be compiled based on reviews of each travel destination, promotional literature for that travel destination, and the like. In a preferred embodiment, the data and information in the qualities database may be used for searching travel arrangements via the concierge service.

FIGS. 10A and 10B show the second step of the method 1000, which may be accessing the website on one or more computer systems by one or more users 1010. A user of a computer system may access the webpages of the website by utilizing a computer system. The computer system may be any device with a processor and may comprise a web browser that may be configured for a user to visit or access the website to perform the method 100. After initializing a web browser, the user may visit or access the website.

FIGS. 10A and 10B show the third and fourth steps of the method 1000, which may be prompting the one or more users to input a budget, one or more points of origin, and one or more travel dates by the website 1015 and inputting the budget, the one or more points of origin, and the one or more travel dates by the one or more users 1020. After accessing the website, the website may provide the user with one or more prompts. Specifically, the website may ask the user to input a budget for booking travel arrangements, points of origin, and travel dates. The budget is generally an estimate of the user's income and expenditure for the trip. The points of origin is generally the point or place for departure of a trip, and the travel dates are generally the start and end dates, in which the user travels to and from a particular travel destination. Once the user the budget, points of origin, and travel dates, the server may utilize such information for searching travel information.

Given the budget, travel dates, and points of origin, the fifth and sixth steps of the method 100 may be performed, which generally are: searching the one or more databases by the website for a plurality of flights based on the one or more points of origin and the one or more travel dates 1025 and storing the list of selected flights in the at least one server 1030. Here, the budget generally provides the framework, in which the server may search for particular flights. Specifically, the server may utilize the amount of the budget to search for certain airfare that is within the user's budget. Similarly, the server may utilize the travel dates and points of origin to locate certain trips that begin at a particular place and are available at certain time frames. For example, a user may input information such as a budget of $5,000, a point of origin of Los Angeles, Calif., and travel dates of January 1 to January 31. Given such information, the server may search databases of an affiliate airfare network to search for airfare less than or equal to $5,000. Additionally, the server may also search for flights from Los Angeles, Calif. during the time period of January 1 to January 31. After locating the flights that satisfy these criteria, the server may then store a list of selected flights in the server and the search results may be displayed to the user. In an embodiment, the list of selected flights may be displayed from least expensive airfare to the most expensive airfare.

After located the selected flights within the user's budget, the server may calculate the remaining balance of the budget, which is generally the amount of the budget that is less the airfare cost. Given the remaining balance of the budget, the seventh, eighth, and ninth steps of the method 100 are generally performed, which may be: searching the one or more databases for a plurality of accommodations based on a plurality of destinations listed in the list of selected flights, the one or more travel dates, and an accommodations cost that is less than a remaining balance of the budget, such that a plurality of matching accommodations is created that matches up with the plurality of flights on the list of selected flights 1040; storing the one or more plurality of matching accommodations in the at least one server 1045; and displaying to the one or more users the list of selected flights and the plurality of matching accommodations 1050. Here, the remaining budget also provides a framework, in which the server may search for particular accommodations such as lodging and hotels. For example, assuming that the user's budget is $5,000 and that a flight to Japan is $1,000, the server may search databases of an affiliate hotel network to search for matching accommodations less than or equal to $4,000 (i.e., the remaining budget). Similarly, assuming that the user's budget is $5,000 and that a flight to Hong Kong is $1,500, the server may search for matching accommodations less than or equal to $3,500, which is generally the remaining budget. After finding accommodations that are within the remaining budget, the server may then store the matching accommodations in the server. In one embodiment, the matching accommodations may be displayed from most expensive to the least expensive in order to provide the user with best available matching accommodations.

FIGS. 10A and 10B also shows the tenth step of the method 1000, which may be displaying a final balance of the budget to the one or more users 1055. After the search results appear to the user with their corresponding airfare cost and accommodations cost, a final balance may be displayed the user. The final balance is generally the amount of the budget minus the airfare cost and accommodations cost and may displayed to the user as “spare cash”, as shown in FIG. 6.

FIGS. 10A and 10B also shows the eleventh, twelfth, thirteenth, and fourteenth steps of the method 1000, which are additional features of the method, may be prompting the one or more users to select a concierge service 1060; receiving a selection of the concierge service from the one or more users 1065 (this allows the system to take the users destination desires into account); displaying one or more travel destinations based on how the one or more qualities of the destination match up with the desires of the user 1070; and displaying a percentage 1075. The website may prompt or ask the user if the user would like to proceed with concierge server. As discussed above, the concierge service may allow the user to select certain travel destinations based on the dynamic preferences of the user or the desired qualities of the travel destinations. Assuming that the user selects concierge service, the server may perform an additional task of searching the qualities database that contains information as to the qualities of each particular travel destination. The data and information contained in a qualities database may be compiled by a team of well-traveled researchers and may also be compiled based on reviews of each travel destination, promotional literature for that travel destination, and the like. After finding relevant travel destinations based upon certain qualities of the destinations, the search results may be displayed to the user. In various embodiments, the search results of the travel destinations may also show a percentage, which shows show well the listed destinations generally have the qualities desired by the user.

Finally, FIGS. 10A and 10B shows the final step of the method 1000, which may be selecting by the one or more users at least one of the plurality of flights listed on the list of selected flights and at least one of the plurality of matching accommodations, such that an itinerary is created 1080. Given the search results of information regarding airfare, matching accommodations, and travel destinations, the user may select those travel options that he or she desires, thereby creating an itinerary for his or her travel. Alternatively, the user may modify components of the travel options to further customize his or her itinerary. Further, the user may increase his or her airfare budget or modify the airfare by class, dates, and layovers.

Although FIGS. 10A and 10B shows only fifteen steps, it should be understood that any number of steps may be used, and that some steps may be performed at the same time or out of order. For example, steps involving the concierge service may specifically be omitted. The website may also display relevant travel destinations along with the each relevant flight and hotel information.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A method for booking travel arrangements, comprising:
providing at least one server configured to host a website;
providing one or more databases;
wherein said website is configured to access said one or more databases;
accessing said website on one or more computer systems by one or more users;
prompting said one or more users to input a budget, one or more points of origin, and one or more travel dates by said website;
inputting said budget, said one or more points of origin, and said one or more travel dates by said one or more users;
searching said one or more databases by said website for a plurality of flights based on said one or more points of origin and said one or more travel dates;
wherein said plurality of flights have an airfare cost that is less than said budget, such that a list of selected flights is generated;
storing said list of selected flights in said at least one server;
searching said one or more databases for a plurality of accommodations based on a plurality of destinations listed in said list of selected flights, said one or more travel dates, and an accommodations cost that is less than a remaining balance of said budget, such that a plurality of matching accommodations is created that matches up with said plurality of flights on said list of selected flights;
wherein said remaining balance is an amount of said budget less said airfare cost;
storing said one or more plurality of matching accommodations in said at least one server; and
displaying to said one or more users said list of selected flights and said plurality of matching accommodations.

2. The method for booking travel arrangements of claim 1, further comprising:
selecting by said one or more users at least one of said plurality of flights listed on said list of selected flights and at least one of said plurality of matching accommodations, such that an itinerary is created.

3. The method for booking travel arrangements of claim 1, wherein said website does not prompt said one or more users to enter one or more travel destinations when said one or more users input said budget.

4. The method for booking travel arrangements of claim 1, wherein said displaying step of said plurality of matching accommodations further comprises the step of:
displaying said plurality of matching accommodations from most expensive to least expensive.

5. The method for booking travel arrangements of claim 1, further comprising:
displaying a final balance of said budget to said one or more users;
wherein said final balance is an amount of said budget less said airfare cost and an accommodations cost.

6. The method for booking travel arrangements of claim 1, wherein at least one of said one or more databases comprise a qualities database;
wherein said qualities database comprises a data of one or more qualities of one or more travel destinations.

7. The method for booking hotel and travel of claim 4, further comprising the step:
prompting said one or more users to select a concierge service;
wherein said concierge service is configured to allow said one or more users to search one or more travel destinations based on said one or more qualities of said one or more travel destinations.

8. The method for booking travel arrangements of claim 6, wherein said one or qualities is selected from the group of qualities consisting of: a geographic region, a seasonal activity, and a language.

9. The method for booking travel arrangements of claim 6, further comprising the step of:
displaying said one or more travel destinations based on said one or more qualities.

10. The method for booking travel arrangements of claim 6, wherein said displaying step of said one or more travel destinations based on said one or more qualities, further comprises the step of:
displaying a percentage;
wherein said percentage is a proportion of said one or more qualities in relation to said one or more travel destinations.

11. A method for booking travel arrangements, comprising:
providing at least one server configured to host a website;
providing one or more databases;
wherein said website is configured to access said one or more databases;
accessing said website on one or more computer systems by one or more users;
prompting said one or more users to input a budget, one or more points of origin, and one or more travel dates by said website;
inputting said budget, said one or more points of origin, and said one or more travel dates by said one or more users;
searching said one or more databases by said website for a plurality of flights based on said one or more points of origin and said one or more travel dates;
wherein said plurality of flights have an airfare cost that is less than said budget, such that a list of selected flights is generated;
storing said list of selected flights in said at least one server;
searching said one or more databases for a plurality of accommodations based on a plurality of destinations listed in said list of selected flights, said one or more travel dates, and an accommodations cost that is less than a remaining balance of said budget, such that a plurality of matching accommodations is created that matches up with said plurality of flights on said list of selected flights;
wherein said remaining balance is an amount of said budget less said airfare cost;
storing said one or more plurality of matching accommodations in said at least one server;
displaying to said one or more users said list of selected flights and said plurality of matching accommodations; and
selecting by said one or more users at least one of said plurality of flights listed on said list of selected flights and said plurality of matching accommodations, such that an itinerary is created.

12. The method for booking travel arrangements of claim 11, wherein said website does not prompt said one or more users to enter one or more travel destinations when said one or more users input said budget.

13. The method for booking travel arrangements of claim 12, wherein said displaying step of said plurality of matching accommodations, further comprises the step of:
displaying said plurality of matching accommodations from most expensive to least expensive.

14. The method for booking travel arrangements of claim 13, further comprising:
displaying a final balance of said budget to said one or more users;
wherein said final balance is an amount of said budget less said airfare cost and said accommodations cost.

15. The method for booking travel arrangements of claim 14, wherein at least one of said one or more databases comprise a qualities database;
wherein said qualities database comprises a data of one or more qualities of said one or more travel destinations.

16. The method for booking hotel and travel of claim 15, further comprising the step:
prompting said one or more users to select a concierge service;
wherein said concierge service is configured to allow said one or more users to search said one or more travel destinations based on said one or more qualities of said one or more travel destinations.

17. The method for booking travel arrangements of claim 16, wherein said one or qualities is selected from the group of qualities consisting of: a geographic region, a seasonal activity, and a language.

18. The method for booking travel arrangements of claim 17, further comprising the step of:
displaying said one or more travel destinations based on said one or more qualities.

19. The method for booking travel arrangements of claim 18, wherein said displaying step of said one or more travel destinations based on said one or more qualities, further comprises the step of:
displaying a percentage;
wherein said percentage is a proportion of said one or more qualities in relation to said one or more travel destinations.

20. A method for booking travel arrangements, comprising:
providing at least one server configured to host a website;
providing one or more databases;
wherein said website is configured to access said one or more databases;
accessing said website on one or more computer systems by one or more users;
prompting said one or more users to input a budget, one or more points of origin, and one or more travel dates by said website;
inputting said budget, said one or more points of origin, and said one or more travel dates by said one or more users;
wherein said website does not prompt said one or more users to enter one or more travel destinations when said one or more users input said budget;
searching said one or more databases by said website for a plurality of flights based on said one or more points of origin and said one or more travel dates;
wherein said plurality of flights have an airfare cost that is less than said budget, such that a list of selected flights is generated;
storing said list of selected flights in said at least one server;
searching said one or more databases for a plurality of accommodations based on a plurality of destinations listed in said list of selected flights, said one or more travel dates, and an accommodations cost that is less than a remaining balance of said budget, such that a plurality of matching accommodations is created that matches up with said plurality of flights on said list of selected flights;
wherein said remaining balance is an amount of said budget less said airfare cost;
storing said one or more plurality of matching accommodations in said at least one server;
wherein at least one of said one or more databases comprise a qualities database;
wherein said qualities database comprises a data of one or more qualities of said one or more travel destinations.
prompting said one or more users to select a concierge service;
wherein said concierge service is configured to allow said one or more users to search said one or more travel destinations based on said one or more qualities of said one or more travel destinations;
receiving a selection of said concierge service from said one or more users;
displaying to said one or more users said list of selected flights, said plurality of matching accommodations, a final balance of said budget, one or more travel destinations based on said one or more qualities, and a percentage;
wherein said final balance is an amount of said budget less said airfare cost and said accommodations cost;
wherein said percentage is a proportion of said one or more qualities in relation to said one or more travel destinations; and
selecting by said one or more users at least one of said plurality of flights listed on said list of selected flights and at least one of said plurality of matching accommodations, such that an itinerary is created.
